(19) United States
(12) Patent Application Publication
(10) Pub. No.: US 2021/0392725 A1
(43) Pub. Date: Dec. 16, 2021

(54) HEATING APPARATUS AND METHODS FOR HEATING

(71) Applicant: Yizhou LIN, Santa Clara, CA (US)

(72) Inventor: Yizhou LIN, Santa Clara, CA (US)

(21) Appl. No.: 17/344,239

(22) Filed: Jun. 10, 2021

Related U.S. Application Data
(60) Provisional application No. 63/037,265, filed on Jun. 10, 2020.

(51) Int. Cl. H05B 6/68; H05B 6/64; H05B 6/72

(52) U.S. Cl. CPC H05B 6/687; H05B 6/72; H05B 6/6435

(57) ABSTRACT

A heating apparatus that applies energy waves to an item located therein includes a main body including a cavity that houses the item, and an energy beam module that converts power from at least one power source into at least one energy beam, and emits the at least one energy beam to intersect with the item, which is directed to the item by at least one of a beam convertor or at least one wall of the cavity. At least one processor determines a plurality of power distributions of energy beams onto at least one surface of the item in respective different configurations of the energy beam module, determines at least one power distribution of the determined plurality of power distributions based on attributes of the item, and controls the energy beam module to perform heating of the item by emitting the energy beams to the item based on the determined at least one power distribution.

### BACKGROUND

The exemplary embodiments generally relate to systems, apparatuses, and methods for directing energy waves, such as electromagnetic waves, for the purpose of, for example, cooking liquid and solid food products.

Energy waves, which are used to describe ways in which energy is transferred, such as electromagnetic waves, are used in a heating process for items (e.g., food) used in daily life. A microwave oven is a known example used for a variety of functions, such as heating food items. A microwave is a type of electromagnetic wave in a frequency range approximately between 300 MHz to 300 GHz, where the exact range definition varies depending on the particular use of the microwave. A heating process for heating items using directed microwaves is known as a dielectric heating method.

In a dielectric heating process, when a subject item is placed in the path of an electromagnetic wave, molecules forming the subject item move to attempt to align to the electromagnetic field. The molecules forming the subject item contain electric dipoles, which align upon interacting with the electromagnetic wave. Rapid movements of the electric dipoles during alignment generate a release of energy (i.e., heat) in the subject item. Food materials, such as water, fat, and other ingredients are affected by dielectric heating process, so the dielectric heating can be easily applied to heating food.

### SUMMARY

The embodiments discussed herein are directed to systems, apparatuses, and methods for directing energy waves, such as electromagnetic waves, to subject items, such as food items, for cooking and/or heating the subject items. The exemplary embodiments may be applied to different apparatuses that implement energy waves to perform heating of one or more subject items, such as a microwave oven, convection oven, conduction oven, radio frequency (RF) oven, air fryer, etc.

For exemplary and illustrative purposes, the embodiments discussed herein will refer to a microwave oven, but are not meant to be limited to only a microwave oven. It is known that the microwave oven has significant usage in the cooking world.

In general, a microwave oven operates by first converting electrical energy into electromagnetic energy, which is then converted into thermal energy for heating a subject/item in an oven cavity of the microwave oven. The microwave oven of the exemplary embodiments may also implement heating using additional types of heating processes, such as radio-frequency based heating, infra-red light based heating, etc., that apply different types of energy waves to the subject item. The exemplary microwave oven then converts the different energy causing a temperature increase of the subject item.

Despite the wide popularity and convenience of the conventional microwave oven, the conventional microwave oven still has disadvantages that the exemplary embodiments improve upon. For example, the conventional microwave oven performs a heating process that has undesired or uneven temperatures in the heated subject item(s) (e.g., food) due to material composition and/or positions of the heated subject item(s) (e.g., food) within the cavity of the microwave oven. In addition, heating food items using electromagnetic waves requires complex interactions and configurations in order to heat multiple food items (e.g., a meal) that is formed from several subject items. For example, a microwave may perform a process to “heat for 4½ minutes, then remove a muffin out of the microwave oven, stir a mashed potato, and then heat the mashed potato for another 3 minutes.” Thus, the conventional microwave oven was not able to provide targeted heating to the multiple food items of, e.g., a meal.

The systems, apparatuses, and methods of the exemplary embodiments described herein provide multiple improvements over the conventional microwave oven, such as a flexible and precise heating process for heating one or more subject items, such as food. The systems, apparatuses, and methods described herein provide dynamic directional (targeted) and configurable generation of electromagnetic waves within a cavity of the exemplary microwave oven to solve the inconvenience mentioned above of incomplete, inconvenient, and burdensome heating of food items. The systems, apparatuses, and methods described also open a door to the cavity for many other applications, such as advanced automatic culinary process.

To achieve the improvements to the above-mentioned problems, the exemplary embodiment(s) provide a heating apparatus, and corresponding method, configured to apply energy waves to an item located in the heating apparatus. The heating apparatus includes a main body including a cavity enclosed within the main body, the cavity being configured to house the item; an energy beam module configured to convert power from at least one power source into at least one energy beam, and emit the at least one energy beam to intersect with the item located in the cavity, the emitted at least one energy beam being directed to the item by at least one of a beam convertor or at least one wall of the cavity; and at least one processor programmed to: determine a plurality of power distributions of energy beams onto at least one surface of the item in respective different configurations of the energy beam module, determine at least one power distribution of the determined plurality of power distributions based on attributes of the item, and control the energy beam module to perform heating of the item by emitting the energy beams to the item based on the determined at least one power distribution.

### BRIEF DESCRIPTION OF THE DRAWINGS

FIG. 1 illustrates an isometric view of a heating apparatus according to an embodiment.

FIG. 2 illustrates a block diagram illustrating an exemplary heating apparatus according to an embodiment.

FIG. 3 illustrates an infra-red parabola reflector sending a directed energy beam.

FIG. 4 illustrates an example of an exemplary Configurable Beam Delivery submodule.

FIG. 5 illustrates an example of an exemplary Configurable Beam Delivery submodule that creates energy distribution of a configurable shape.

FIG. 6 illustrates an exemplary representation of three-dimensional surfaces of a subject item generated by an exemplary Sensor Module.

FIG. 7 illustrates an exemplary illustration of a projection and calculation of energy beams according to an embodiment.

FIG. 8 illustrates an exemplary configuration and time interval sequence to reach a temperature target according to an embodiment.

### DETAILED DESCRIPTION

The exemplary embodiments define systems, apparatuses, and methods designed to heat a subject item, such as food, using directable energy waves, such as electromagnetic waves. In the following of the description, the term “beam” is used to represent any form of energy waves with a preferred direction that the energy is transferring toward. A beam may propagate in parallel (e.g., a laser), or converge, or diverge (e.g., a flashlight beam). The following description refers to a “subject item”, which may include, but is not limited to, one or more objects to be at least partially heated, such as a cup of water, chicken wings, a packaged frozen meal, an uncooked pizza, etc. The systems, apparatuses, and methods of the exemplary embodiments convert electrical power into energy beams, which intersect with the subject item for a period of time in order to heat the subject item. Hereinafter, the exemplary apparatus, for may be known, for example, as an advanced microwave oven 100 for the simplicity of explanation.

Overview of Structure of Exemplary Advanced Microwave Oven

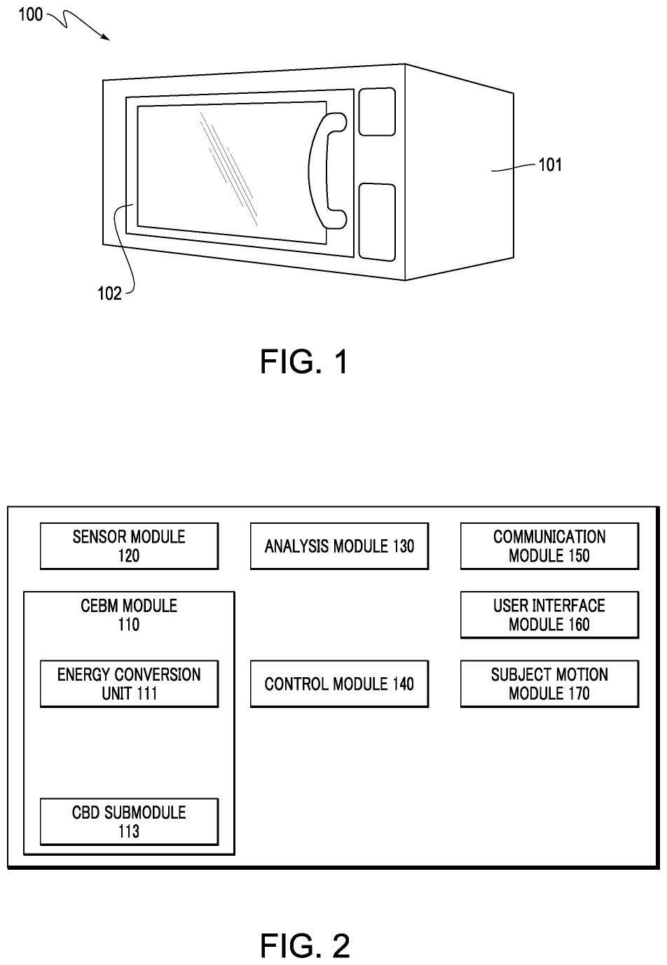

As shown in FIG. 1, the exemplary advanced microwave oven apparatus 100 includes a main body 101 having a door 102, a power source 103, and a cavity 104 formed within the main body 101 that may be accessed and/or closed by the door 102. The cavity 104 has an inner wall 104a that reflects energy beams E.

As shown in FIG. 2, the microwave oven apparatus 100 further includes a Configurable Energy Beam Module (CEBM Module) 110, a Sensor Module 120, an Analysis Module 130, and a Control Module 140. As discussed in more detail below, additional embodiments of the microwave oven apparatus 100 further include any one or more of a Communication Module 150, a User Interface Module 160, and/or a Subject Motion Module 170. The exemplary microwave oven apparatus 100 may be of a various size or various shape. The microwave oven apparatus 100 may be, for example, a countertop microwave oven, a commercial sized oven, or a larger cooking device.

Description of the Configurable Energy Beam Module 110

The Configurable Energy Beam Module 110, abbreviated herein as the CEBM Module, is an energy source for heating the subject item(s). The CEBM 110 includes at least one energy conversion unit 111, such as a magnetron, in the microwave oven. The energy conversion unit 111 converts electrical power into energy waves that are directed into a single beam or multiple beams. The beam(s) is/are then directed as an energy beam E or multiple energy beams E into the cavity 104. The CEBM 110 performs functions in response to receiving a control signal from the Control Module 140. In response to receiving the control signal from the Control Module 140, the CEBM 110 generates and transmits the energy beam E or energy beams E from the CEBM 110 in targeted directions with a set (configurable) intensity and a set (configurable) cross-sectional shape.

The at least one energy conversion unit 111 transmits the energy beam(s) to the subject item to heat the subject item. The energy beam(s) may be in any frequency of the electromagnetic spectrum that can heat the subject item, such as microwave, RF wave, infra-red wave, etc. Further, other energy beams, such as ultrasound beams, may also be implemented to heat the subject item.

As an alternative, the CEBM 110 may include multiple energy conversion units 111. As a further alternative, the CEBM 110 may generate energy beams in multiple frequency spectrums together. By generating and transmitting energy beams in multiple frequency spectrums, the microwave oven apparatus 100 is able to achieve different heating effects, such as causing different penetration depths into the subject item, which accordingly improves the heating efficacy and efficiency of the microwave oven apparatus 100.

The improved capability of the CEBM 110 to generate and transmit the energy beam(s) from the CEBM 110 in targeted directions with a set (configurable) intensity and a set (configurable) cross-sectional shape provide improvements over the conventional microwave ovens by improving heating efficiency of the subject item(s), and being able to precisely control the heating effects on different portions of the subject item(s). The improved microwave oven apparatus 100 is able to define how the energy beams are generated and provide targeted transmission of the generated energy beams to the subject item(s) within the cavity 104. The exemplary microwave oven apparatus 100 and corresponding method(s) include, but are not limited to, the following description.

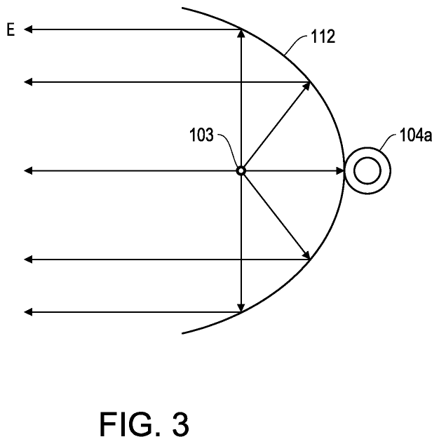

FIG. 3 illustrates that the CEBM 110 further includes a parabola reflector 112 that is located on or within the inner wall 104a of the cavity 104. The parabola reflector 112 reflects/directs an outputted energy beam E from the power source 103, which is located at a focal point of the parabola reflector 112. The parabola reflector 112 reflects/directs the energy beam E in an opening direction of the parabola reflector 112, as shown in FIG. 3. The CEBM 110 includes a mechanical motor attached to the parabola reflector 112 that controls and moves the parabola reflector 112 to direct the output energy beam E at an angle determined by an input instruction signal from the Control Module 140. The mechanical motor moves the parabola reflector 112, by rotation, translation, pivoting, etc., such that the parabola reflector 112 is positioned and configurable accordingly to the control signal from the Control Module 140. Thus, the power source 103 is a directable and configurable power source.

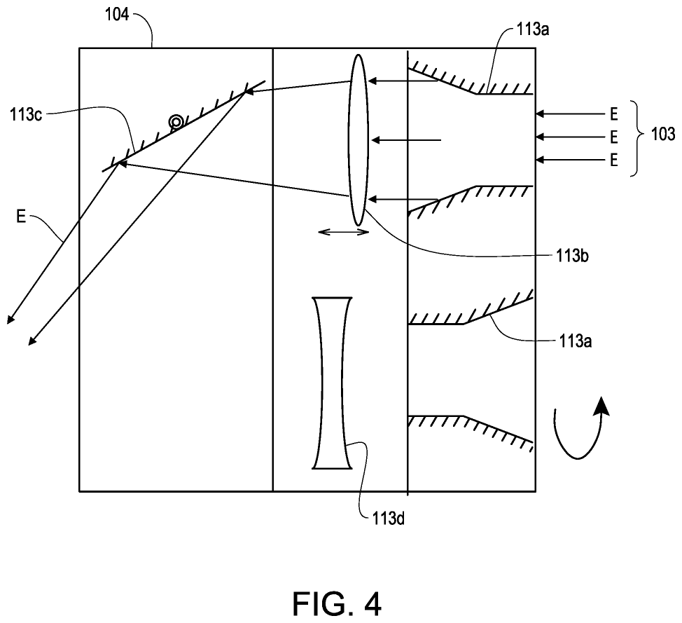

FIG. 4 illustrates an embodiment in which the CEBM 110 includes a Configurable Beam Delivery (CBD) submodule 113, abbreviated as the CBD submodule, that generates an electromagnetic beam. The CBD submodule 113 is located on or within the inner wall 104a of the cavity 104. The CBD submodule 113 includes a series of components, including, but not limited to, one or more of a waveguide, an electromagnetic lens, a super lens, a mirror reflector, a parabolic reflector, a beam shaper, a phased array, and/or a shield. The series of components of the CBD submodule 113 are beam converters that redirect an original electromagnetic beam generated from the power source 103, and create directed and controlled energy beams E. Beam converters may also include components that absorb the energy beam E. For example, another example of a beam convertor is one or more containers of water that are filled up or empty in order to absorb and shape microwave beams.

Each energy beam E is propagated in a parallel propagation, (i.e. keep same cross section), or converge (reduce cross section), or diverge (increase cross section), depending on a distance of a reflecting path between the CBD submodule 113 and the subject item located in the cavity 104. The shape of the cross section of energy beam E is configured by a shape(s) of the beam converters that the beam passed through. Motors may be used to precisely move or rotate the beam converters, so each beam is positioned into a desired angle controlled by the Control Module 140. Each beam convertor of the CBD submodule 113 may have a motor, or a single motor may operate multiple beam convertors of the CBD submodule 113.

FIG. 4 shows an example of a CBD submodule 113 including two different shapes of waveguides 113a, an electromagnetic lens 113b, a mirror reflector 113c, and a beam shaper 113d. Energy beams E enter one waveguide 113a from the power source 103 (not shown in FIG. 4), and pass through the electromagnetic lens 113b and then are directed by the mirror reflector 113c. This is merely one non-limiting example of a configuration of beam convertors of the CBD submodule 113.

The motor or multiple motors controlling the positions of the beam convertors of the CBD submodule 113 allow for multiple configurations of the CBD submodule 113 by combining different converters. For example, when an energy beam E passes through a convex lens, with two mirror reflectors of different axes, and where each has n1, n2, n3 configurations, there may be up to a total of n1×n2×n3 configurations. This configuration allows for multiple energy beams E of the same frequency, or energy beams E of different frequencies, to co-exist at the same time. Therefore, this structure allows for easy creation of numerous configurations by the CBD submodule 113, which may be configured for a particular application or use to achieve optimal or improved heating efficiency.

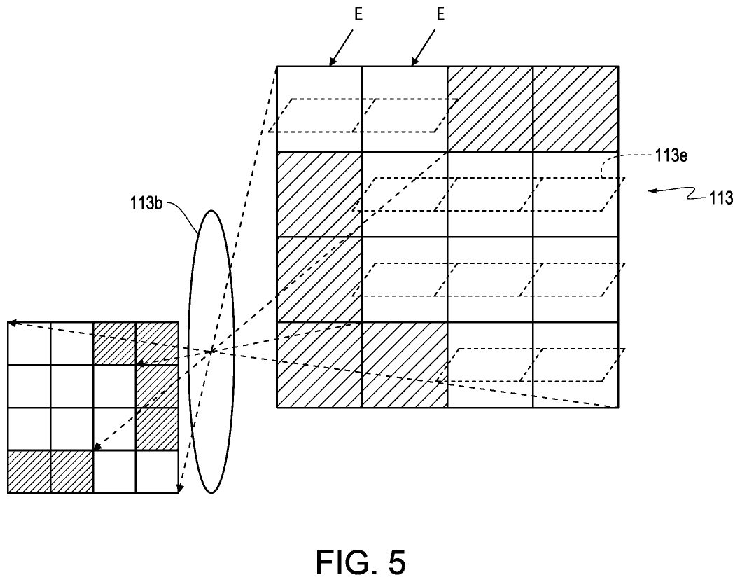

FIG. 5 illustrates a representative example of one configuration of the CBD submodule 113, which may be configured into different directions and shapes. FIG. 5 illustrates an example of a beam converter configuration of the CBD submodule 113 that has a grid of size m×n, where each slot on the grid may be configured to pass or block one or more energy beams E. In the exemplary illustration of FIG. 5, the CBD submodule 113 includes a configurable filter 113e that includes a 4×4 grid of openings. In the configurable filter 113e, six slots are blocked and ten slots are configured to allow energy beams E to pass through the CBD submodule 113. In the example of FIG. 5, a lens 113b and a rotatable mirror reflector 113c are combined with the filter 113e to create a cross sectional shape of the energy distribution of the energy beams E that “pass through” the CBD submodule 113 and are transmitted by the CEBM Module 110.

In addition, or as an alternative to the above configuration, there are multiple additional methods/functions to configure energy beam intensity, such as to configure the energy beam intensity from the power source 103, or control the path length that the energy beam E reflects between the inner wall 104a of the cavity 104 before intersecting with the subject item. In fact, the reflection path and reflection angle of the energy beam E between the inner walls of the cavity significantly increases the number of power distribution patterns when considering how the beam intersects with the subject(s), and therefore, improves the capability of the microwave oven apparatus 100 to heat any specific portions of the subject(s) as desired.

It is also possible that for some implementation, there is a portion of non-directed energy (portion of the energy beam E) that is transmitted by, or passes through, the CEBM module 110, which could be implemented to contribute to heating the entire cavity 104 and accordingly a surface of the subject item relatively evenly. An example of this non-directed energy may be background noise. As discussed in more detail below, the Analysis Module 130 will incorporate this non-directed energy (portion of the energy beam E) into the analysis of heating the subject item.

The CEBM Module 110 may be one physical structure, or one or more detached structures positioned in different locations around or within the cavity 104 to improve a beam delivery angle of the energy beams E. For example, in a configuration in which the CEBM Module 110 is composed of multiple structures, one structure of the CEBM Module 110 is placed on the side of the inner wall 104a of the cavity 104 in a position relatively closer to the energy source than another separate structure of the CEBM Module 110, which is placed on a ceiling (different portion of the inner wall 104a) of the cavity 104 to conveniently reflect the energy beams E to target a center of the subject item from above (from the ceiling) of the cavity 104.

Description of the Sensor Module 120

The Sensor Module 120 is formed of at least one or more sensors, such as imaging sensors, temperature imaging sensors, ultrasound sensors, or sensor to measure electromagnetic wave strength etc. In addition, one or more of the sensors may include sources that help the sensors to function, such as, for example, a visible light source for the purpose of image capture.

The Sensor Module 120 acquires sensor data that is transmitted to and input into the Analysis Module 130. The sensor data acquired or detected by the Sensor Module 120 is input into the Analysis Module 130 to evaluate a status of the subject item, a status of the cavity 104, and/or a status of the microwave oven apparatus 100. The sensor data input may include, but are not limited to, visible imaging (images, video, etc.) of the subject item, a temperature image/map or detection of the subject item, an edge image of the subject item, movement of the subject item, energy wave strength within the cavity 104, an image of the cavity 104, etc.

Description of the Analysis Module 130

The Analysis Module 130 performs computations and determinations of the microwave oven apparatus 100. The Analysis Module 130 is implemented by one or more computers including one or more processors and one or more storage devices. The one or more processors may be any type of programmed computational device, such as central processing units (CPU), microprocessors, microcontrollers, networked computer systems, application specific integrated circuits, field programmable gate array, etc., or a specialized processor designed for performing analysis tasks. The one or more storage devices may be a computer readable storage medium that includes memory devices, storage media readable by a removable media drive, and/or a hard disk drive, such as random access memory (RAM), read-only memory (ROM), magnetic hard disks, optical storage discs, etc., for storing one or more software modules of instructions that control the processor to perform various operations.

The Analysis Module 130 performs multiple processing steps/functions, including but not limit to:

Step 1) constructing, determining, and/or estimating a three-dimensional (3D) surface structure of the subject item;

Step 2) calculating, determining, and/or estimating an energy power distribution pattern applied on a surface of the subject item for a set of configurations of the CEBM Module 110;

Step 3) determining a configuration and time interval sequence to achieve a pre-determined or desired heating result of the subject item; and

Step 4) instructing the Control Module 140 to perform a heating sequence in accordance with the determined configuration and time interval sequence.

The Analysis Module 130 may also perform additional enhancement features, including, but not limited to, iterative adjustment. During iterative adjustment, the Analysis Module 130, after a time period T, acquires and analyzes all input data to determine a temperature increment of different areas of the cavity 104 and/or the subject item. The Analysis Module 130 then recalculates and adjusts the configuration and time interval sequence (determined in Step 3) accordingly. Each of the steps of the Analysis Module 130 will be discussed in more detail below.

For Step 1, the Analysis Module 130 acquires the sensor data input from the Sensor Module 120 to construct a three-dimensional (3D) image or virtual representation of the cavity 104 and/or the subject item(s). The Analysis Module 130 executes known methods and/or algorithms to construct the 3D image or virtual representation of the surface of the subject item or of the cavity 104, and to identify a material or materials of the subject item(s).

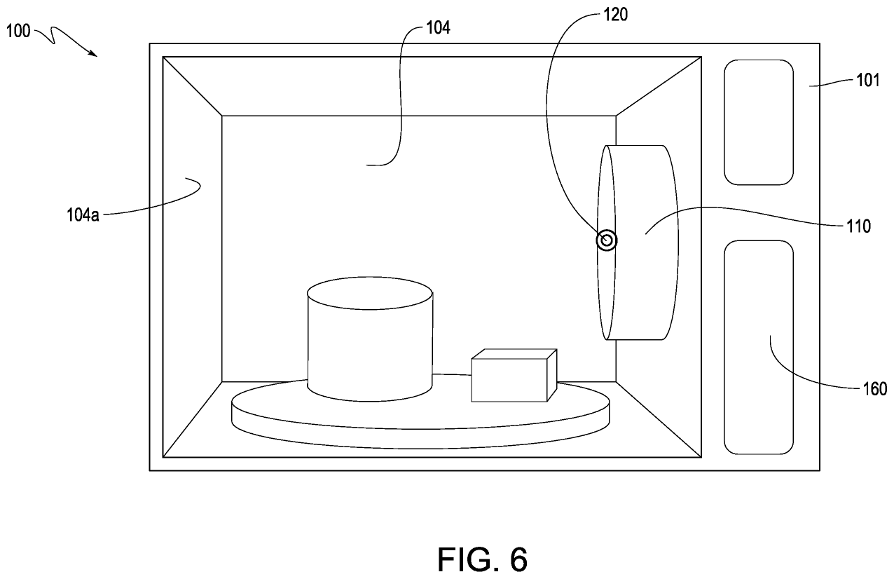

FIG. 6 illustrates an example of three-dimensional surfaces of the subject item acquired by the Sensor Module 120. As a non-limiting example, the sensor data input from the Sensor Module 120 is images of a subject item located in the cavity 104. From the inputted images of the subject item, the Analysis Module 130 executes deep/machine learning algorithms to perform image recognition to recognize the subject item as a particular food item, such as steak, vegetable, or seafood, etc. The Analysis Module 130 then determines or estimates attributes of the subject item based on identifying the food item, such as weight, heat capacity, etc. The Analysis Module 130 may access a stored database to identify a heat capacity and a weight of the subject item. The heat capacity may the specifically determined or found in the database, or estimated from data about the identified food item corresponding to the subject item.

Due to the potential complexity of the subject items located in the cavity 104, the Analysis Module 130 may not be able to directly observe or assess attributes of the subject item. In this situation, the Analysis Module 130 combines multiple pieces of inputted data from the Sensor Module 120 to collectively, or through aggregating the inputted data, determine the attributes of the subject item. For example, the Analysis Module 130 combines captured images from the Sensor Module 120 that are captured in one or more different frequency spectrums, such as the infra-red spectrum for a thermal image. The Analysis Module 130 then determines the subject item by a behavior of the subject item in response to or during heating.

In addition, or as an alternative, additional data about the subject item or used to identify the subject item may be derived by imaging, inputting, or scanning a bar code or QR code associated with the subject item. The bar code or QR code may be located on the subject item itself or separately accessible.

The Analysis Module 130 also incorporates additional factors into the analysis for constructing the 3D image or virtual representation of the cavity 104 and/or the subject item(s), which are set as a target or multiple targets for heating. The factors may be alternatives or in addition to the above-discussed factors. The factors for identifying the subject item(s) and for determining attributes about the subject item(s) include, but are not limited to, user input, user preference, instructions, stored heating recommendation, and crowdsourced heating recommendations, derived or predicted heating recommendation, etc.

The subject item(s) may contain different elements, such as a frozen meal that has steak as one element and a vegetable as another element. In this case, the temperature and the time required for complete heating may vary differently for each element due to different attributes of the elements (i.e., food items). In particular, the temperature and the time required for complete heating may vary differently for each element due to different surface areas of the different elements.

Without loss of generality, as an example, the subject item(s) (or different elements forming the subject item(s)) has a heating target temperature as an attribute of the subject item(s) to be identified by the Analysis Module 130. A heating target temperature may be represented in the form of a function of TempTarget(T, x, y, z), for a time of T and at a 3-D coordinate space that belongs to the surface of the subject item and an internal space of the subject item. The subject item(s) may have multiple acceptable target temperatures for the subject item as a whole or for each element of the subject item, such as a range of temperatures or a range of time, to heat the subject item. In this situation, as one example, achieving any target among the set of heating target temperatures may be considered as achieving the heating target temperature.

The Analysis Module 130 may also acquire the image of the cavity alone to estimate the shape and measurement of the cavity for the purpose of computation in Step 2.

For Step 2, the Analysis Module 130 analyzes the shapes and quantities of power or energy distributions on the 3D image or virtual representation of the surface of the subject item (as determined in Step 1), as well as in a 3D interior space of the subject item to determine penetration depth of the energy beam(s) E. For purposes of explanation, the shapes and quantities of power or energy distribution are referred to hereinafter as “distribution patterns”. In Step 2, the Analysis Module 130 determines multiple distribution patterns for energy beams intersecting or hitting the subject item based on the 3D image or virtual representation of the surface of the subject item and the 3D interior space of the subject item.

For each configuration of the 3D image or virtual representation of the surface of the subject item and the 3D interior space of the subject item, a number of energy beams E are directed/transmitted from of the CEBM Module 110 at specified or set angles. Since the shape and measurement of the cavity 104 has already been determined or is known, either from the manufacturer of the apparatus, or as estimated from Step 1, the Analysis Module 130 computes a reflection path of the energy beam(s) E.

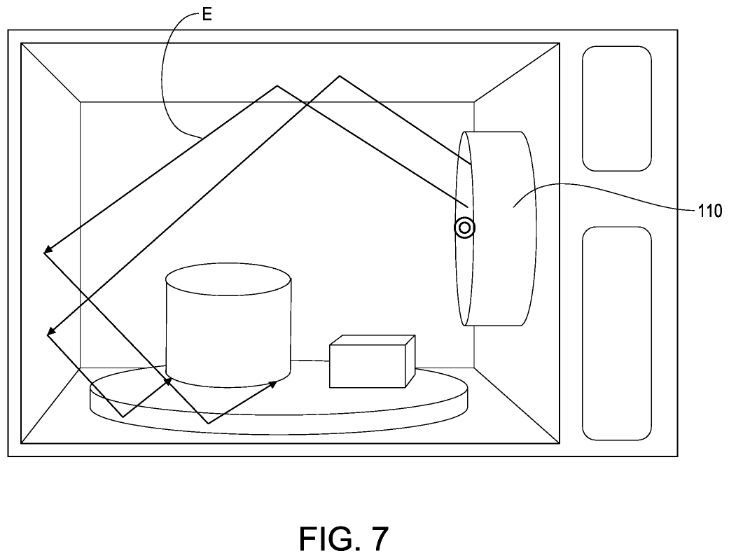

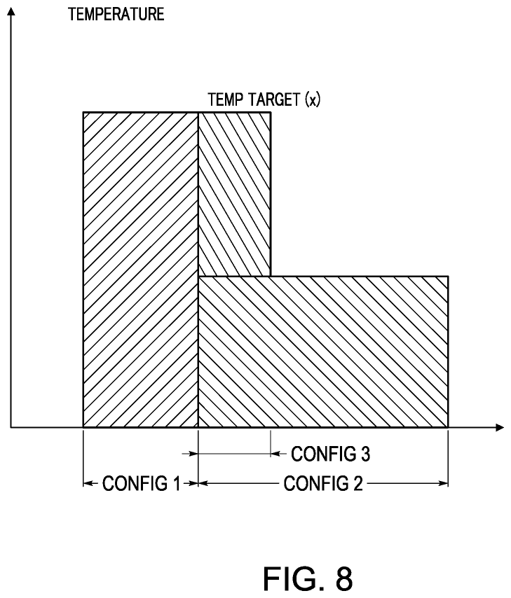

For example, FIG. 7 illustrates an example of a calculated projection of the power distribution of energy beams E. The Analysis Module 130 computes the reflection path by calculating a geometry of the shapes of the energy beam(s) E and energy quantities applied to the surface of the subject item in the 3D image or virtual representation and beneath the surface in the 3D interior space of the subject item. The geometry of the shapes of the energy beam(s) E and the energy quantities are distribution patterns.

The detailed computation distribution patterns may consider multiple energy wave related effects, including, but not limited to, reflection between cavity walls of the inner wall 104a of the cavity 104, diffraction, resonate effects, etc. The distribution patterns may be computed by known mathematical methods, such as 3D geometry and calculus.

An advantage of the configurability of the CEBM module 110 is that the CEBM module 110 may generate multiple different energy beam configurations, where the energy beams may hit/intersect the subject item after various instances of reflections with the cavity 104. Due to the significant amount of potential configuration, the set of all configurations of the energy beams E may be too large to efficiency compute all distribution patterns. In this case, computer aided optimization algorithms, or similar processes, may be used to selectively compute possible candidate sets first, which reduces computation load on the microwave oven apparatus 100.

For Step 3, the Analysis Module 130 determines a sequence of a configuration and a time interval to achieve a predetermined or desired subject heating result of the subject item. Each configuration includes an estimated distribution pattern from Step 2 determined for a given surface area of the subject item and for a penetration depth beneath the surface of the subject item. The Analysis Module 130 calculates an estimated sequence that includes a distribution pattern and a time interval value, which results in a total energy transmitted to the surface area and beneath the surface of the subject item. Since the material under the surface of the subject item may not be observable, the Analysis Module 130 may further account for multiple factors in this determination, such as common knowledge about foods, or observed temperature increase rate, to make an estimation or calculated approximation about the material. The Analysis Module 130 then uses different energy propagation rates through the estimated/calculated material(s) to estimate an expectation of temperature increase.

The Analysis Module 130 executes processing that implements an algorithm, for example, that uses the set of configurations of the distribution patterns determined in Step 2, and calculates a configuration and time interval sequence that achieve one of the desired subject heating target TempTarget(T, x, y, z) from a set of acceptable heating targets.

FIG. 8 is a simplified graphical representation of a configuration and time interval sequence. FIG. 8 is simplified for illustrative purposes only so as to show only a one-dimension coordinate TempTarget(x), instead of the three-dimensional coordinates of TempTarget(T, x, y, z), as discussed above. This illustrated example does not limit the description of the three-dimensional coordinates herein.

In FIG. 8, the function TempTarget(x) contains the upper edges in the graph, which corresponds to two different temperature requirements for two portions of the subject item of the x axis segments respectively. In order to reach TempTarget(x), the Analysis Module 130 determines, in Step 3, three candidate configurations—Config1, Config2, Config3—for segments on the x axis. Configurations may have different energy distributions, and for the simplicity of illustration only, the example of FIG. 8 assumes the energy/power distribution is evenly distributed within each segment.

Config1 has a time t1 to reach the higher edge in TempTarget(x); Config2 has a time t2 to reach the lower edge in TempTarget(x); and Config3 is applied and has a time t3 to increase the middle part temperature from lower edge to higher edge. Therefore, in Step 3, the Analysis Module 130 determines that the configuration and time interval sequence (Config1, t1), (Config2, t2), (Config3, t3) achieves/satisfies TempTarget(x).

In addition, the Analysis Module 130 may also incorporate into the determination in Step 3 temperature differences (i) between adjacent surfaces, (ii) between adjacent volumes beneath the surface, (iii) thermal propagation effects, (iv) liquid movement, (v) subject item movement, etc.

Thus, the exemplary embodiment(s) account for propagation of energy beams/power distribution on the surface and within the subject item, and determine multiple sequences that achieve similar heating effects on the subject item. With this flexibility, the Analysis Module 130 may implement different algorithms to optimize other objectives of heating process, such as reducing motor movements in the CEBM Module 110, reducing overall waiting time, etc.

In a further embodiment, depending on the number of available configurations and the algorithms used, Step 2 and Step 3 may also be combined together, or in interleaving steps for an efficient or better solution. For example, Step 2 select an initial configuration set to start, and Step 3 first selects a set of configurations and time intervals from this initial set, then identifies some neighboring candidate configurations with good quality. The Step 2 analysis is then performed on the new configuration candidates, and Step 3 selects a better set of configurations and time intervals using the enlarged candidate configuration set, identifies new candidate configurations, and then repeats these processes until an optimal solution that meets criteria is found. In addition, some distribution patterns could be pre-calculated and stored in advance of Steps 2 and Step 3 for faster determination/estimation.

For a given time point, the above-computation may also incorporate a projected location for the 3D surface of the subject item, in the event that a Subject Motion Module 170 moves the subject item on a guided path. The Subject Motion Module 170 will be discussed in more detail below.

The above-mentioned algorithm may also be implemented on a separate device with, for example, an ASIC chip, an FPGA chip, an AI chip, or external devices, such as a mobile phone, a cloud server etc., for optimal computation and instructions.

For Step 4, the Analysis Module 130 transmits a signal to the Control Module 140 instructing the Control Module 140 to carry out the configuration and time interval sequence determined in Step 3. The processing of the Control Module 140 will be discussed in more detail below.

In a further embodiment, due to potential propagation of energy, movement of the subject item, and the nature (liquid, solid, etc.) of the composition of the subject item, Step 1 may also be performed with other Steps in an iterative manner (feedback loop). Meaning, the Sensor Module 120 could be used to capture the status in the cavity 104 repeatedly in order to dynamically confirm the progress of the heating of the subject item towards the target temperature, and adjust the configuration and time interval sequence determined in Step 3 (and implemented in Step 4) iteratively.

Description of the Control Module 140

The Control Module 140 is implemented similar to the Analysis Module 130 discussed above, and may be formed within the same or different one or more computers. As discussed above, the one or more computers include one or more processors and one or more storage devices.

The Control Module 140 receives the signal from the Analysis Module 130 instructing the Control Module 140 to carry out the configuration and time interval sequence determined by the Analysis Module 130. When user prefers to directly control the CEBM Module 110, the user may be able to send the sequence directly to the Control Module. The Control Module 140 accordingly executes the configuration and time interval sequence by transmitting the configuration to the CEBM Module 110 at a set timing for the time interval sequence.

The Control Module 140 causes the microwave oven apparatus 100 to perform heating of the subject item. The resulting heating operation provide for more effective and efficient heating of the subject item for a broader range of heating operations.

In addition to the above-mentioned features, the exemplary embodiment(s) may include one or more of the following modules for the exemplary microwave oven apparatus 100, which further enhance the functionality and usability of the heating apparatus and system.

Description of the Communication Module 150

The exemplary microwave oven apparatus 100 also includes a Communication Module 150 that connects microwave oven apparatus 100 to one or more external devices through wired communication, or wireless communication methods, such as Bluetooth, Wi-Fi, mobile cell phone protocols, or any customized protocols. In order to avoid electromagnetic wave interruption, shielding may also be included for parts/modules that are placed inside the cavity 104.

The Communication Module 150 provides communication with external devices to enhance the on-going functioning of the microwave oven apparatus 100 by allowing for software updates with better analysis and/or control algorithms. The Communication Module 150 may also allow an external device, such as a computer, a cell phone, or a cloud platform/server, to perform more accurate and complex analysis and control the apparatus by communication.

Description of the User Interface Module 160

The exemplary microwave oven apparatus 100 also includes a User Interface Module 160 that displays information and status of the subject item and the microwave oven apparatus 100. The User Interface Module 160 also receives external instructions inputted by the user. The information and statuses may include, but are not limited to, an image of the subject item, a temperature image of the subject item, an average temperature, a highest/lowest temperature, a current heating surface(s) of the subject item, an estimated time to finish heating the subject item or a portion of the subject item, etc. The inputted instructions from the user may include, but are not limited to, selecting a mode of operation, adjusting targeted subject temperature and regions, adjusting maximum heating time, etc.

The User Interface Module 160 may include a display and may be interactive on the microwave oven apparatus 100. The User Interface Module 160 may have a wireless or wired connection to other devices, such as a cell phone, tablets, computer monitor, or cloud devices. The User Interface Module 160 could also connect and interact with user predesigned program or script for flexible and automatic control.

For example, the User Interface Module 160 may be implemented by an input/output (I/O) interface. The I/O interface allows the user or another external device to input to and receive data from the modules. The I/O interface also allows control of the various operations performed by the modules. For example, the I/O interface may include one or more input devices, such as a keyboard, a pointing device (e.g., a mouse, a track ball), a touch-sensitive display, microphone, etc. The I/O interface may also comprise one or more output devices, such as a display (including a touch-sensitive display).

Description of the Subject Motion Module 170

As discussed above, the exemplary microwave oven apparatus 100 also includes the Subject Motion Module 170 to move the subject item around inside the cavity 104 for better heating distribution. The Subject Motion Module 170 may be implemented by various mechanical hardware structures, such as a carousel, a rotatable shelf, and/or a container that can be automatically tumbled (vertically rotated), or automatically stirred.

The Subject Motion Module 170 moves the subject item to enable the energy beams E to be delivered in different angles, and to be accessible to additional surface area of the subject item. Some motion, such as tumble and stir movement, accelerates the thermal propagation, simulates human-based cooking. The motion caused by the Subject Motion Module 170 also allows the Sensor Module 120 to capture a new 3D surface structure and current temperature, and then the Analysis Module 130 calculates/determines a new/updated configuration and time interval sequence for heating the subject item.

The Subject Motion Module 170 may include, or be driven by, various types of power sources, such as one or more mechanical or electromechanical motors. The Subject Motion Module 170 may also be powered or controlled by known devices that cause the above-mentioned movement of the structure of the Subject Motion Module 170.

Method

A method of the functioning and an operation of the heating apparatus is incorporated into and inherent in the description set forth herein of the structure and operation of the heating apparatus.

Modifications

In addition to the above-described features and embodiment(s), the exemplary microwave oven apparatus 100 may include additional features that further increase the functionality and usability of the microwave oven apparatus 100.

The structure of the microwave oven apparatus 100 or the algorithms implemented above to achieve the configuration and time interval sequence for heating the subject item may be modified or combined with other heating factors to achieve different or additional heating objectives, such as cooking efficiency and quality. For example, the microwave oven apparatus 100 may be combined or work in conjunction with a conventional oven, convection oven, air fryer, etc., to assist or to speed up the heating of surface and interior of the subject item for additional cooking procedures.

Further, in a moving hot air environment, the energy beams E may have different propagation speeds when the air medium has different temperatures, and therefore the directed energy beam angle may vary slightly when the air temperature is significantly uneven inside the cavity. A self-adjustment or self-calibration Module or submodule may be implemented to determine compensation for the energy beam angle to achieve accurate heating of the subject item. For example, this self-adjustment feature would function with the CEBM Module 110 to transmit an energy beam E in a certain direction that reflects back towards an energy wave sensor when the air temperatures are even. If the energy wave sensor receives the energy beam E right in the middle, then no adjustment is needed around the beam path; otherwise, the beam angle will be fine-tuned until the energy wave sensor(s) captures the beam. Then, the compensation angle will be calculated by analyzing this data.

There are existing electromagnetic wave-based heating apparatuses, such as conventional microwave ovens. The exemplary embodiment(s) described herein may be retrofitted as an add-on sub-apparatus to utilize the existing power source and cavity to enhance the cooking experience.

The add-on device may have the Sensor Module 120, the CBD submodule 113, the Analysis Module 130, and the Control Module 140, and utilize the existing electromagnetic wave generated in existing microwave oven. The add-on may be placed inside the cavity 104 to cover an existing waveguide entrance on the inner wall 104a of the cavity 104, and therefore the microwave may come into the cavity 104 passing through the CBD submodule 113. If the inner wall 104a of the cavity 104 is formed by materials, such as steel, the add-on could possibly be attached to the cavity 104 by magnets.

Due to an existing concern of a microwave producing electricity in the metal parts, the electronic parts placed inside the cavity 104 may be shielded by structures, such as a Faraday cage, etc. A small power source that drives the modules may use a wireless charging method, which is placed outside the shield and directly drawing wireless energy from the microwaves. Some or all of the modules, such as the CBD submodule 113, do not require much power, and a small wireless charging battery would provide sufficient power for operation.

In addition, for a special type of heating effect or cuisine style, for example, grilling, microwave oven apparatus 100 may implement special types of beam patterns, such as high energy focus with stripe-shaped cross section. Pre-designed replaceable converters for the CBD submodule 113 may be provided to implement the special type of heating effect. The pre-designed converter may help to increase the heating quality for the certain cooking methods.

Given a certain subject item or surface of the subject item to be heated, there are multiple ways to configure the energy beam paths with different angles. Therefore, the Analysis Module 130 may select among multiple determined beam paths with a similar heating result. For example, the Analysis Module 130 could be configured to select only safe beam configurations that avoid passing through recognized metal subjects, which avoid electricity discharges of metal subject under microwave radiation.

Another consideration is for radiation safety of the microwave oven apparatus 100. For example, some users may be concerned about the energy leakage from an observable door side of the inner wall 104a of the cavity 104. To address this type of concern, the Analysis Module 130 may avoid or reduce using any beam path that utilizes an observable door side as a reflecting surface. This consideration could also improve on the quality of the energy beam E, since a metal mesh of the door 102 may have different reflection property comparing to a smooth metal surface.

For energy radiations that are less accurately controlled by the CEBM Module 110, the energy beams E may be caused to reflect around the inner wall 104a of the cavity 104 and hit the subject item at a random (unintended) area/surface. This is a type of background energy effect. If the required energy differences are insignificant between the surface areas, the Analysis Module 130 may utilize the background energy as a roughly even heating, and implement a feedback mechanism to adjust when necessary.

When the required heating differences are significant between different surface areas, a following mechanism may be implemented to remove part or a significant portion of the background energy. Thus, a solution is provided to significantly reduce uncontrollable energy leak. For example, a small amount of materials may be disposed on a corner of the cavity 104 that can absorb the energy wave, such as, using water to absorb microwave. The Analysis Module 130 may direct a desired energy beam E to avoid that specific area, while the background wave could be significantly reduced. For heavy usage, such as commercial purpose heating, another enhanced idea is to place a mesh of water pipe in the cavity 104 where moving water flows through the water pipe and brings the background energy out of the cavity 104, similar to a liquid cooling system.

The above-mentioned embodiments are examples of the apparatuses and methods that achieve the improvements set forth herein. The above-mentioned apparatuses and methods may be combined in any manner to result in a system to provide the improvements discussed herein.

As discussed above, the above-mentioned exemplary embodiments of the apparatuses and method are not limited to the examples and descriptions herein, and may include additional features and modifications as would be within the ordinary skill of a skilled artisan in the art. The alternative or additional aspects of the exemplary embodiments may be combined as well.

1. A heating apparatus configured to apply energy waves to an item located in the heating apparatus, the heating apparatus comprising:
a main body including a cavity enclosed within the main body, the cavity being configured to house the item;
an energy beam module configured to convert power from at least one power source into at least one energy beam, and emit the at least one energy beam to intersect with the item located in the cavity, the emitted at least one energy beam being directed to the item by at least one of a beam convertor or at least one wall of the cavity; and
at least one processor programmed to:
determine a plurality of power distributions of energy beams onto at least one surface of the item in respective different configurations of the energy beam module,
determine at least one power distribution of the determined plurality of power distributions based on attributes of the item, and
control the energy beam module to perform heating of the item by emitting the energy beams to the item based on the determined at least one power distribution.

2. The heating apparatus according to claim 1, wherein the beam convertor of the energy beam module includes one or more of a waveguide, an electromagnetic lens, a super lens, a mirror reflector, and a beam shaper.

3. The heating apparatus according to claim 1, wherein the at least one energy beam includes a plurality of energy beams, and the energy beam module is configured to control a cross-sectional shape of the plurality of energy beams.

4. The heating apparatus according to claim 1, wherein the at least one processor is programmed to:
generate a virtual image of each side surface of the item;
determine a plurality of power distributions of electromagnetic waves onto each side surface of the item; and
determine a combination of a sub-set of power distributions of the plurality of power distributions that correspond to each side surface of the item.

5. The heating apparatus according to claim 4, wherein the at least one processor is programmed to analyze the virtual images of the item to identify the item and determine corresponding heating attributes as the attributes of the item.

6. The heating apparatus according to claim 5, wherein the attributes of the item include a weight of the item and a heating capacity of the item.

7. The heating apparatus according to claim 5, wherein the at least one processor is programmed to:
determine a configuration of an intensity of the electromagnetic waves and a coordinate location on each surface of the item at which the electromagnetic waves intersect to achieve heating of the item;
determine a timing sequence of each power distribution of the sub-set of power distributions for each surface of the item; and
control the power source and the energy beam module to reflect the electromagnetic waves to each coordinate location at the determined intensity based on the determined timing sequence.

8. The heating apparatus according to claim 7, wherein the at least one processor is programmed to control the energy beam module to cause the beam convertor to move to respective positions that reflect the electromagnetic waves to each coordinate location.
